(19) United States
(12) Patent Application Publication
(10) Pub. No.: US 2017/0343745 A1
(43) Pub. Date: Nov. 30, 2017

(54) TUNABLE FIBER OPTIC CONNECTOR

(71) Applicant: Corning Optical Communications LLC, Hickory, NC (US)

(72) Inventor: Joel Christopher Rosson, Hickory, NC (US)

(21) Appl. No.: 15/606,392

(22) Filed: May 26, 2017

Related U.S. Application Data
(60) Provisional application No. 62/343,361, filed on May 31, 2016.

(51) Int. Cl. G02B 6/38

(52) U.S. Cl. CPC G02B 6/3871; G02B 6/3874; G02B 6/3821; G02B 6/387

(57) ABSTRACT

A fiber optic connector having a ferrule extending along a longitudinal axis and a ferrule holder from which the ferrule extends. The fiber optic connector also includes a housing having a housing body in which the ferrule holder is received and a housing cap configured to be attached to the housing body. The housing cap defines a front end of the housing when attached to the housing body. The ferrule holder and housing body allow rotation of the ferrule holder relative to the housing body about the longitudinal axis when the housing cap is not attached to the housing body. The housing cap restricts rotation of the ferrule holder relative to the housing body about the longitudinal axis when the housing cap is attached to the housing body.

### CROSS-REFERENCE TO RELATED APPLICATIONS

This application claims the benefit of priority under 35 U.S.C §119 of U.S. Provisional Application No. 62/343,361 filed on May 31, 2016 the content of which is relied upon and incorporated herein by reference in its entirety.

### BACKGROUND

This disclosure generally relates to fiber optic connectors for use in creating fiber optic cable assemblies when joined with fiber optic cables. More particularly, the present disclosure relates to fiber optic connectors having tunable ferrules.

The transmission of signals through a fiber optic network relies upon fiber optic connectors to patch together separate fiber optic cables and interface between fiber optic cables and other hardware configured to send, receive, relay, or redirect signals. Often, fiber optic connectors use ferrules in an effort to axially align the terminal ends of optical fibers within the fiber optic cables to produce an end-to-end optical connection.

An efficient end-to-end optical connection seeks to maximize light transmission from a source, such as an optical fiber, to a receiver, such as another optical fiber. Transmission may be maximized by reducing any back reflection. Transmission may also be maximized by reducing or eliminating any gap between the terminal end faces of connected optical fibers. Transmission may also be maximized by more closely axially aligning the terminal end faces of connected optical fibers. From a light transmission perspective, in the case of two optical fibers, a key to transmission efficiency is the relative alignment of the core of each optical fiber. Commonly these cores can be on the order of only 9 microns in diameter, making exact axial alignment very difficult to achieve on a consistent basis. For improving axial alignment, fiber optic connectors have been developed with an ability to be tuned. During tuning, portions of the fiber optic connector are moved, such as by rotating, relative to other portions of the fiber optic connector to increase the likelihood of a sufficiently efficient end connection.

A need remains for a tunable fiber optic connector that provides for tuning during manufacture, but also limits or eliminates the possibility that a down-stream user could inadvertently adjust the tuning of the fiber optic connector.

### SUMMARY

One embodiment of the present disclosure relates to a fiber optic connector. The fiber optic connector includes a ferrule extending along a longitudinal axis, a ferrule holder from which the ferrule extends, and a housing having a housing body in which the ferrule holder is received. The housing also includes a housing cap configured to be attached to the housing body. The housing cap defines a front end of the housing when attached to the housing body. The ferrule holder and housing body are configured to allow rotation of the ferrule holder relative to the housing body about the longitudinal axis when the housing cap is not attached to the housing body. However, the housing cap is configured to restrict rotation of the ferrule holder relative to the housing body about the longitudinal axis when the housing cap is attached to the housing body.

In some embodiments, the fiber optic connector is installed on an end of a fiber optic cable to form a fiber optic cable assembly. The fiber optic cable includes at least one optical fiber that is supported in and secured to the ferrule of the fiber optic connector. The fiber optic cable also includes a jacket extending around the at least one optical fiber.

Additionally, in some embodiments, the fiber optic connector may be part of a fiber optic connector system that also includes a cover configured to be attached to the housing body instead of the housing cap to retain the ferrule holder in the housing body. The cover, housing body, ferrule, and ferrule holder are configured so that when the cover is attached to the housing body: a) the ferrule extends through the cover; b) the ferrule holder is movable along the longitudinal axis between a first position in which the ferrule holder engages the cover and a second position in which the ferrule holder is spaced from the cover; c) the cover is configured to restrict rotation of the ferrule holder relative to the housing body about the longitudinal axis in the first position of the ferrule holder; and d) the ferrule holder and housing body are configured to allow rotation of the ferrule holder relative to the housing body about the longitudinal axis in the second position of the ferrule holder.

Methods of forming a fiber optic cable assembly are also provided in this disclosure. One method involves securing at least one optical fiber of a fiber optic cable to a ferrule of a connector pre-assembly. The connector pre-assembly also includes a ferrule holder from which the ferrule extends, a housing body in which the ferrule holder is received, and a cover attached to the housing body to retain the ferrule holder in the housing body. The method further involves tuning the ferrule after securing the at least one optical fiber therein, wherein the tuning of the ferrule comprises causing relative rotation between the ferrule holder and the housing body. However, a housing cap is attached to the housing body in place of the cover to restrict further tuning of the ferrule.

A fiber optic connector as described herein may provide one or more advantages. For example, the fiber optic connector is configured to provide both the proven benefits of ferrule tuning, while minimizing or eliminating the concern of the ferrule becoming un-tuned after leaving the possession of the manufacturer.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. Features and attributes associated with any of the embodiments shown or described may be applied to other embodiments shown, described, or appreciated based on this disclosure.

FIG. 1 is a cross section of an end-to-end connection of two optical fibers held by un-tuned ferrules.

FIG. 2 is a cross section of an end-to-end connection of two optical fibers held by tuned ferrules.

FIG. 3 is an exploded view of a fiber optic connector according to one embodiment.

FIG. 4 is a perspective cross section of the assembled fiber optic connector of FIG. 3 attached to a fiber optic cable.

FIG. 5 is a perspective cross section of a fiber optic connector pre-assembly according to one embodiment.

### DESCRIPTION

Various embodiments will be further clarified by examples in the description below. In general, the description relates to tunable fiber optic connectors, fiber optic cable assemblies comprising the same, and methods of tuning a tunable fiber optic connector. More particularly, this disclosure provides various embodiments where the fiber optic connector is initially tunable as part of a pre-assembly, and is restricted or prevented from being further tuned when arranged as a final assembly. A tunable fiber optic connector allows for adjusting the position of a core of an optical fiber relative to predetermined portions of the fiber optic connector. As used herein, tuneability may be described in terms of the fiber optic connector, or with respect to components of the fiber optic connector (e.g., including connector sub-assemblies), interchangeably.

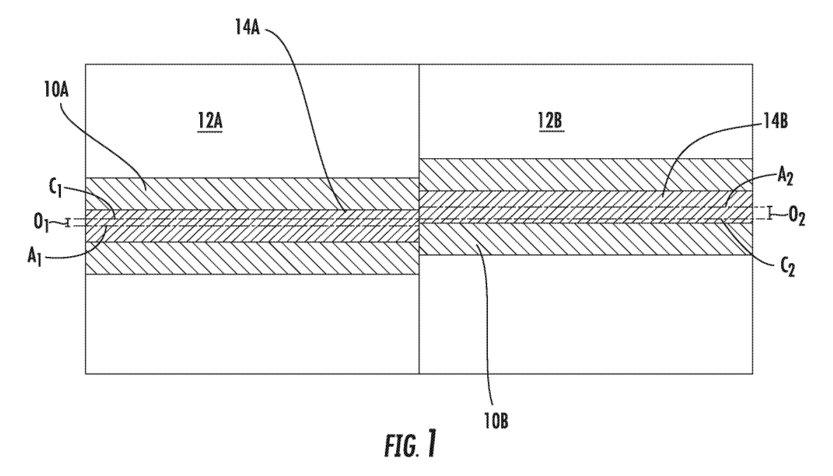

FIG. 1 illustrates an example of relative nonalignment of terminal ends of optical fibers 10A, 10B that are confronting one another. The optical fibers 10A, 10B may be held in their confronting configuration by virtue of being mounted within respective fiber optic connectors that are mated to one another (e.g., using an adapter). Although ferrules 12A, 12B supporting the respective optical fibers 10A, 10B are shown, other connector components (and adapter components, if applicable) are not shown to simplify matters.

In the example shown in FIG. 1, manufacturing or other limitations or challenges have resulted in offsets O1, O2 between true longitudinal axes A1, A2 of the ferrules 12A, 12B and centerlines C1, C2 of cores 14A, 14B of the optical fibers 10A, 10B. Each offset O1, O2 may be characterized using a polar coordinates in a plane transverse to the longitudinal axes. That is, each offset O1, O2 may be considered as having a magnitude (offset distance) and direction (angle measured relative to an x-axis in the polar coordinate system).

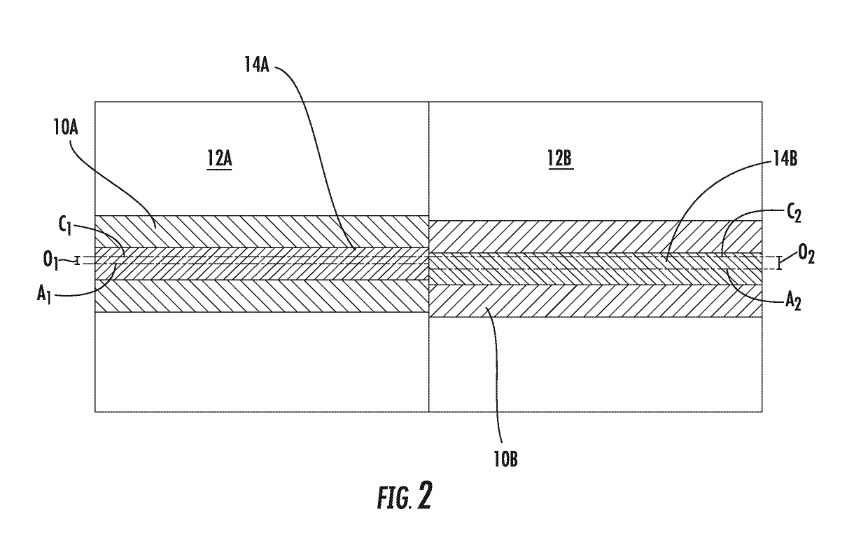

When two connectors are joined together, if the offset O1 of the first connector has a direction opposite to the offset O2 of the second connector, there may be relatively large axial misalignment of the cores 14A, 14B as shown in FIG. 1. In an attempt to reduce such misalignment, a tuning process may be used to move or reorient at least one of the offsets O1, O2 in a predetermined direction relative to its associated fiber optic connector. For example, the tuning may comprise rotating either or both of the ferrules 12A, 12B about their respective longitudinal axes A1, A2 and relative to housings (not shown) of their associated fiber optic connector. FIG. 2 illustrates both ferrules 12A, 12B oriented with their offset O1, O2 in a substantially similar direction. In the illustrated example, the first ferrule 12A may have had the offset O1 thereof already in the predetermined direction, and the second ferrule 12B may have been tuned to position the offset O2 into the predetermined direction by rotating the second ferrule about the longitudinal axis A2. Use of the predetermined direction helps improve the efficiency of transmission without having to know specifically which two fiber optic connectors will be joined together. As a result of this tuning, axial alignment is better in FIG. 2 than in FIG. 1, which can result in improved light transmission between the optical fibers 10A, 10B. The benefits of such tuning may be maintained if a fiber optic connector is prevented from becoming un-tuned.

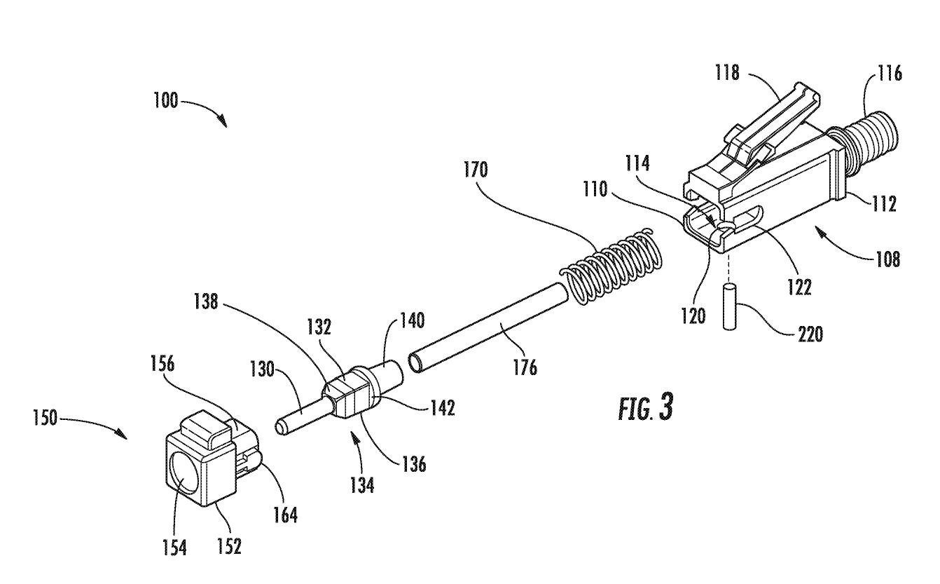

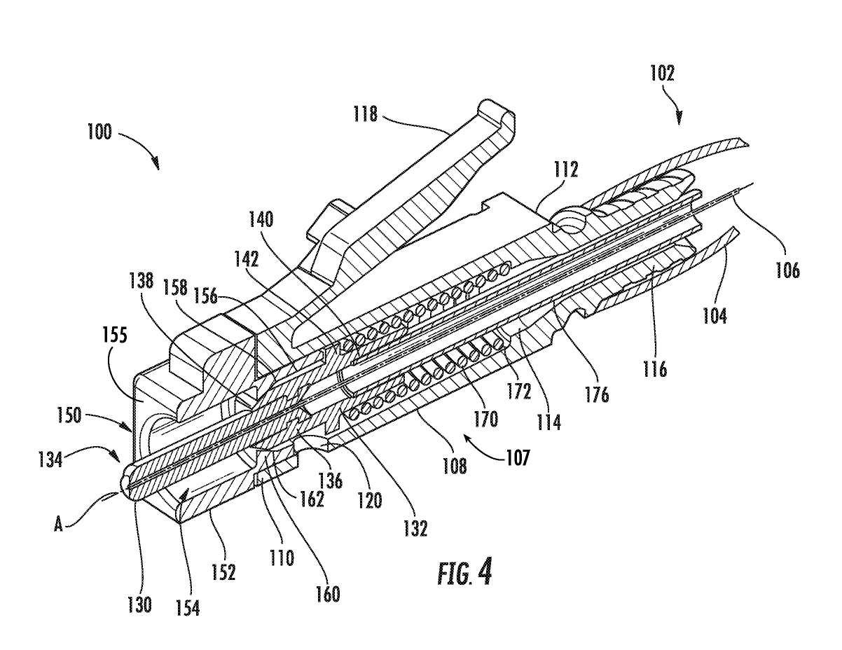

FIG. 3 illustrates an example of a fiber optic connector 100 in an exploded view, and FIG. 4 illustrates the fiber optic connector 100 in an assembled state. FIG. 4 also shows a fiber optic cable 102 attached to the fiber optic connector 100. The fiber optic cable 102 includes a jacket 104 surrounding an optical fiber 106. Reference is now made to these figures collectively.

To this end, the fiber optic connector 100 includes a housing 107, a ferrule holder 132 received in the housing 107, and a ferrule 130 extending from the ferrule holder. The housing 107 includes a housing body 108 with an outer end 110 and an inner end 112, which are defined relative to a length of the fiber optic cable 102. Thus, the inner end 112 faces inward and connects to the fiber optic cable 102, and the outer end 110 faces outward (i.e., away from the fiber optic cable). The housing body 108 may be a molded polymer or other similar material. The housing body 108 may have a unitary structure or be a combination of separate housing portions. As will be discussed in greater detail below, the housing body 108 includes a through-bore 114 having at least a portion that is generally polygonal in shape. In the illustrated embodiment, the through-bore 114 is generally square-shaped. An exterior of the housing body 108 may have any suitable shape, such as a shape consistent with fiber optic connectors known in the art, for mating with existing fiber optic network components, such as ports, or adapters, or the like. The housing body 108 may include a nipple 116 formed integrally with, or attached to, the inner end 112 of the housing body, for at least partially facilitating connection with the fiber optic cable 102. The housing body 108 may also include a fastener 118, such as a flexible latching arm, for the purpose of securing the housing body 108 to an existing fiber optic communication component, such as a port, an adapter, or the like. In some embodiments, the housing body 108 may include one or more apertures 120 through the housing body 108 in communication with the through-bore 114. In the illustrated embodiment, engagement slots 122 are provided in the housing body 108, and the engagement slots extend inwardly from the outer end 110 of the housing body.

As shown in FIGS. 3 and 4, the ferrule 130 includes a ferrule bore (“micro-hole”) that supports the optical fiber 106, which may be secured to the ferrule using a bonding agent (e.g., epoxy or another adhesive). The ferrule 130 is secured to the ferrule holder 132 in the embodiment shown, but in alternative embodiments these components may be a monolithic structure. For convenience, the term “ferrule assembly”, provided as element 134, may be used to refer to the combination of the ferrule 130 and ferrule holder 132, regardless of whether these elements are separate components secured together or different portions of a monolithic structure. Even as separate components, the ferrule 130 is fixed in position relative to the ferrule holder 132.

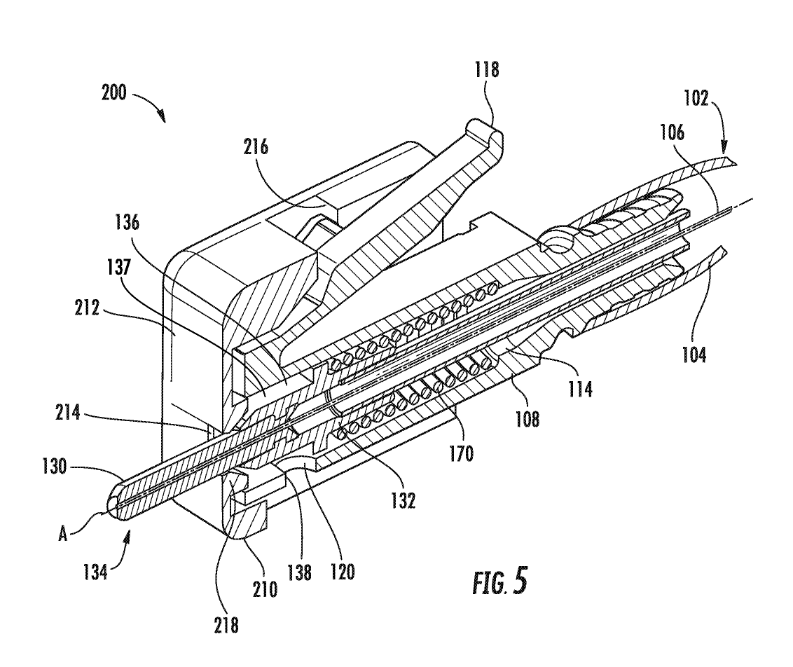

The ferrule holder 132 has a size and shape configured to allow the ferrule holder to reside completely or substantially within the through-bore 114 of the housing body 108. At least a portion of the ferrule 130 may also reside in the through-bore 114 of the housing body 108. In the illustrated embodiment, the ferrule holder 132 has a front portion 136 (also referred to as an outer segment) from which the ferrule 130 extends. The exterior of the ferrule holder 132, particularly the front portion 136, may have a size and shape to form a gap 137 (FIG. 5) between the exterior of the ferrule holder 132 and the inner wall of the through-bore 114 such that the ferrule holder 132 (and, more generally, the ferrule assembly 134) may be rotated within the through-bore. The gap 137 may be a clearance gap having a generally annular shape. The front portion 136 is shown with a polygonal, e.g. square, peripheral shape. The front portion 136 may take other shapes, but non-circular shapes may be beneficial to restrict relative rotation as discussed below. Polygons with a larger number of sides may increase the tuneability of the ferrule assembly 134. For example, the square shown may provide tuneability in 90 degree rotational increments. Providing a hexagon shape may allow for tuneability in 60 degree increments. The forward portion of the front portion 136 may be chamfered to create a series of angled abutment surfaces 138. The abutment surfaces 138 may be oblique to a longitudinal axis A of the ferrule 130. The abutment surfaces 138 may taper from the peripheral walls of the front portion 136 toward a leading face of the outer segment. In the illustrated example, the forward portion of the front portion 136 has the shape of a truncated four-sided pyramid producing four abutment surfaces 138. The number of abutment surfaces 138 may vary but is open equal to the general polygon shape of the front portion 136 as a whole.

In one embodiment, the ferrule holder 132 includes a rear portion 140 (also referred to as an inner segment), shown with a cylindrical periphery. The rear portion 140 has a smaller cross-sectional profile than the front portion 136 in a plane transverse to the longitudinal axis of the ferrule 130. A flange 142 may extend from the periphery of the ferrule holder 132 and define the boundary between the front portion 136 and the rear portion 140 such that the flange is positioned between the outer and rear portions of the ferrule holder 132.

The fiber optic connector 100 may also include a housing cap 150 as a removable portion of the housing 107. The housing cap 150 includes a first portion 152 configured to extend from the housing body 108 and a second portion 156 configured to be received in the housing body. Thus, the first portion 152 may define the front end 155 of the housing 107 when the housing cap 150 is attached to the housing body 108. If desired, the first portion 152 and the periphery of the outer end 110 of the housing body 108 may have complimentary geometry. In other words, the first portion 152 of the housing cap 150 and the outer end 110 of the housing body 108 have respective outer surfaces defining respective outer profiles in a plane transverse to the lengthwise direction of the housing 107, and the outer profile of the first portion 152 may correspond to the outer profile of the outer end 110.

The second portion 156 of the housing cap 150 acts as a restricting insert, as be described in greater detail below. In the embodiment shown, the second portion 156 is in the form of a sleeve such that the term “sleeve 156” will be used in the description below, even though the second portion may have alternative shapes/configurations. The sleeve 156 includes a hollow passage 158 in communication with a cavity 154 defined by the first portion 152 of the housing cap 150. The radially outer circumference of the sleeve 156 may be configured in shape and size to closely fit within the through-bore 114 of the housing body 108 at the outer end 110 of the housing body 108. The radially inner circumference of the sleeve 156 may be configured in shape and size to closely surround the front portion 136 of the ferrule holder 132. Thus, the hollow passage 158 may be configured to receive the front portion 136 of the ferrule holder 132 when the housing cap 150 is attached to the housing body 108. In the embodiment shown, the hollow passage 158 and the first portion 136 of the ferrule holder 132 have polygonal profiles in a plane transverse to the lengthwise direction of the housing 107. The sleeve 156 is configured to be inserted into the gap 137 between the exterior of the ferrule holder 132 and an inner surface of the through-bore 114. The close fit, and the polygonal shape, of is such that the ferrule holder 132 (and ferrule assembly 134 in general) is prevented from rotating within the through-bore 114 when the housing cap 150 is in place.

A ledge 160 may extend into at least one of the cavity 154 and the hollow passage 158, or may define the boundary between the cavity 154 and the hollow passage 158. The ledge 160 may extend around all or some of the circumference of the cavity 154, or hollow passage 158, respectively. The ledge 160 may be provided with one or more mating surfaces 162.

In one embodiment, the ledge 160 extends inward around the full circumference of the housing cap 150 and has a quantity of mating surfaces 162 corresponding to the number of abutment surfaces 138 on the ferrule holder 132. The mating surfaces 162 are also oriented to match the abutment surfaces 138. Thus, the mating surfaces 162 may be oblique to a centerline of the cavity 154 and the hollow passage 158 respectively. The configuration of the mating surfaces 162 and the abutment surfaces 138 is not limited to the embodiment illustrated. The mating surfaces 162 and the abutment surfaces 138 are configured such that at least one mating surface 162 can contact at least one abutment surface 138 in a face-to-face manner in at least two rotational positions of the ferrule assembly 134 relative to the housing cap 150.

The housing cap 150 may also include one or more locking members 164, such as snap features, for securing the housing cap 150 to the housing body 108. In the illustrated embodiment, a pair of locking members 164 are provided in the form of projections on either side of the sleeve 156. The locking members 164 are configured to be retained adjacent to the outer end 110 of the housing body 108 by the engagement slots 122. The engagement slots 122 may have a resilient character to clamp around the projections of the locking members 164. The engagement slots 122 and the locking members 164 may be referred to as at least one set of complementary locking features configured to secure the housing cap 150 to the housing body 108.

The fiber optic connector 100 is assembled by positioning the ferrule assembly 134 within the through-bore 114 of the housing body 108 such that the front portion 136 faces outward relative to the housing body. The housing cap 150 may then be attached to the housing body 108 by sliding the sleeve 156 into the through-bore 114 from the outer end 110 of the housing body until the locking members 164 fully engage the engagement slots 122. The sleeve 156 is inserted into the gap 137 between the exterior of the front portion 136 of the ferrule holder 132 and the inner wall of the through-bore 114, adjacent to the outer end 110 of the housing body 108. The sleeve 156 may be disposed around, in some cases substantially surrounding, the front portion 136 of the ferrule holder 132 with a portion of the ferrule 130 extending into the cavity 154 of the housing cap 150. Rotation of the ferrule holder 132 is substantially prevented or restricted about the longitudinal axis A relative to the housing body 108 when the housing cap 150 is attached to the housing body 108. In other words, connecting the housing cap 150 to the housing body 108 substantially rotationally fixes the ferrule holder 132 (and, therefore, ferrule 130) relative to the housing body 108. For example, the ferrule holder 132 may be restricted from rotating more than 10 degrees, more than 5 degrees, or completely (i.e., no rotation permitted) relative to the housing body 108. Rotation is prevented because the sleeve 156 at least partially fills the gap 137 that previously allowed for rotation. The through-bore 114, sleeve 156, and front portion 136 each have a shape, e.g. polygonal, that limits rotation.

While rotation of the ferrule holder 132 is generally prevented when the housing cap 150 is in place, the ferrule holder 132 (and ferrule assembly 134 in general) may be able to translate relative to the housing body 108 and the housing cap in the direction parallel to the longitudinal axis A of the ferrule 130. An outward position of the ferrule holder 132 relative to the housing 107 may be referred to as a mated position, shown in FIG. 4, because the abutment surfaces 138 contact the mating surfaces 162 of the ledge 160 in a generally face-to-face manner. An inward position of the ferrule holder 132 relative to the housing 107 may be referred to as an unmated position when the abutment surfaces 138 are spaced from the mating surfaces 162 of the ledge 160.

The fiber optic connector 100 may optionally include a spring 170, such as a compression spring. The spring 170 may be disposed within the through-bore 114 of the housing body 108. The spring 170 may be disposed around the rear portion 140 of the ferrule holder 132. The spring 170 may be compressed by contact between a shoulder 172 at the inner end of the through-bore 114 and the flange 142 extending around the ferrule holder 132. The spring 170 may be configured to bias the ferrule assembly 134 in an outward, forward direction relative to the housing body 108, toward the mated position. In one embodiment, the spring 170 is configured to assume a fully compressed state when the ferrule assembly 134 is in the unmated position. Thus, while axial translation of the ferrule assembly 134 along the longitudinal axis A is possible, the magnitude of such translation may be minimized to allow only enough range of motion as necessary to mate and unmate the ferrule assembly 134 with the housing cap 150 (or the cover as discussed below). Excessive translation of the ferrule assembly 134 can buckle and overstress the optical fiber 106 inserted and held within the ferrule 130.

The fiber optic connector 100 may also optionally include a lead-in tube 176. The lead-in tube 176 may extend from the rear portion 140 of the ferrule holder 132 and reside substantially within the through-bore 114 of the housing 108. The lead-in tube 176 may provide additional support and protection to the optical fiber 106 as the optical fiber proceeds towards and is ultimately held within the ferrule 130.

As shown in FIG. 4, the fiber optic cable 102 is attached to the fiber optic connector 100. The jacket 104 of the fiber optic cable 102 may be disposed around the nipple 116 as the optical fiber 106 is routed through the optional lead-in tube 176. A boot (not shown) may be provided around the jacket 104 and the nipple 116.

As mentioned above, when the housing cap 150 is installed on the housing body 108, the ferrule 130 is restricted or prevented from rotating relative to the housing, which may be desired for a customer-ready fiber optic connector 100. In contrast, prior to final assembly of the fiber optic connector 100 (e.g., prior to the housing cap 150 being mounted to the housing body 108), the ferrule 130 may be rotatable, i.e. tunable, relative to the housing body 108.

To accommodate tuning prior to final assembly of the fiber optic connector 100, a fiber optic connector pre-assembly 200 (hereafter “pre-assembly”) may be provided, for example as shown in FIG. 5. The pre-assembly 200 includes at least the housing body 108 and ferrule assembly 134 of the fiber optic connector 100. The pre-assembly 200, however, includes a cover 210 instead of the housing cap 150 (FIG. 4). As the name suggests, the pre-assembly 200 is configured to be a combination of assembled components that are combined as a module for attachment to a terminal end of the fiber optic cable 102 generally as discussed above. While the components of the pre-assembly 200 may be individually assembled onto the fiber optic cable 102, the process of manufacturing a fiber optic cable assembly may be expedited when a pre-assembly 200 is installed as a module onto the fiber optic cable 102 generally as discussed above.

The cover 210 has an outer wall 212 with an opening 214 therethrough for passage of the ferrule 130 when the cover 210 is engaged with the housing body 108. Thus, in one embodiment, the cover 210 exposes at least some of the outer end of the ferrule 130. Exposing the outer end of the ferrule 130 may simplify manufacturing processes such as the simultaneous polishing of the outer end of the ferrule and the terminal end of the optical fiber 106 extending through the ferrule.

The cover 210 may include a keeper groove 216 configured to interact with the fastener 118 on the housing body 108, such that the cover 210 is selectively mountable to, and releasable from the housing via the keeper groove and the fastener. When the cover 210 is mounted to the housing body 108, the cover holds the ferrule assembly 134 within the housing. Without the cover 210, the spring 170 may cause the ferrule assembly 134 to be ejected from the through-bore 114.

An inner surface of the outer wall 212 of the cover 210 may be provided with a beveled seat 218 surrounding the opening 214 and configured to engage one, some, or all of the abutment surfaces 138 of the ferrule holder 132 when the ferrule assembly 134 is in its forward, mated position. In contrast to the sleeve 156 (FIG. 4) of the housing cap 150, the beveled seat 218, if present, may extend inwardly from the outer wall 212 only to the extent necessary to contact at least one of the abutment surfaces 138, and not to substantially surround the front portion 136 of the ferrule holder 132. Thus, while the cover 210 is installed on the housing body 108, the ferrule 130 may be tuned, i.e. rotated, relative to the longitudinal axis A and housing body. The ferrule assembly 134 is movable inwardly from a first position in which the ferrule holder 132 engaged the cover 210 toward the second, unmated position in which the ferrule holder is spaced from the cover. The ferrule 120 is then tuned by rotating the ferrule assembly 134 within the through-bore 114. In the first position, the cover 210 may be configured to restrict rotation of the ferrule assembly 134 relative to the housing body 108 about the longitudinal axis A because of the beveled seat 218. The inward translation of the ferrule assembly 134 may be small, such as by being approximately 0.5 mm or less in one embodiment. In one embodiment, the beveled seat 218 may be omitted, in which case inward translation of the ferrule holder 132 may not be required prior to rotation thereof, even when the cover 210 is mated to the housing body 108. The spring 170 may act to return the ferrule assembly 134 to the mated position once an external, rearwardly translating force has been removed.

In one embodiment, the cover 210 positions the ferrule 130 and ferrule holder 132 in a location slightly outward relative to the housing body 108 as compared to the mated position of the ferrule assembly 134 when contacting the housing cap 150 (FIG. 4). Therefore, when installing the housing cap 150, the ferrule assembly 134 is displaced slightly inward, and excess optical fiber 106 is “stuffed” into the fiber optic cable 102. A strength member (not shown) of the fiber optic cable 102 may be mechanically affixed to the housing 107. This excess fiber “stuffing” can be advantageous to certain fiber optic cable designs as it is generally preferred to have the optical fiber 106 longer than the strength member in fiber optic cable assemblies.

As part of a method of forming the fiber optic connector 100 from the pre-assembly 200, a tool 220 (FIG. 3), set screw, or other tool may be permanently or temporarily inserted into the aperture 120 of the housing body 108 to retain the ferrule assembly within the housing body 108 while the cover 210 is being removed and replaced by the housing cap 150. The tool 220 may also maintain the tuned orientation of the ferrule assembly 134 relative to the housing body 108. In some embodiments, the tool 220 may be able to sufficiently retain the ferrule assembly 134 within the housing body 108 such that the cover 210 may be omitted from the pre-assembly 200 altogether. In some embodiments, the tool 220 may be removed from the aperture 120 after the housing cap 150 has been installed.

Embodiments of the present disclosure may be considered in terms of a kit or fiber optic connector system having the component parts for creating both the pre-assembly 200 and the finished fiber optic connector 100.

Embodiments of the present disclosure may include a method of creating a fiber optic cable assembly. The method may include connecting a terminal end of a fiber optic cable 102 to a fiber optic connector pre-assembly 200, including securing an optical fiber 106 of the fiber optic cable 102 into a ferrule 130 of the pre-assembly. After securing the optical fiber 106 into the ferrule 130, the ferrule may be tuned by rotating the ferrule (or the holder thereof) relative to a housing body 108 of the pre-assembly 200 about a longitudinal axis A of the ferrule. Once tuned, the ferrule 130 may be rotationally fixed relative to the housing 107 by removing a cover 210 of the pre-assembly 200 from the outer end 110 of the housing body 108 and attaching a housing cap 150 to the outer end of the housing body to complete formation of a fiber optic connector 100.

Persons skilled in fiber optic connector technology will appreciate additional variations and modifications of the devices and methods already described. Additionally, where a method claim below does not explicitly recite a step mentioned in the description above, it should not be assumed that the step is required by the claim. Furthermore, where a method claim below does not actually recite an order to be followed by its steps or an order is otherwise not required based on the claim language, it is not intended that any particular order be inferred.

The above examples are in no way intended to limit the scope of the present invention. It will be understood by those skilled in the art that while the present disclosure has been discussed above with reference to examples of embodiments, various additions, modifications and changes can be made thereto without departing from the spirit and scope of the invention as set forth in the claims.

1. A fiber optic connector, comprising:
a ferrule extending along a longitudinal axis;
a ferrule holder from which the ferrule extends; and
a housing comprising:
a housing body in which the ferrule holder is received; and
a housing cap configured to be attached to the housing body, the housing cap defining a front end of the housing when attached to the housing body;
wherein:
the ferrule holder and housing body are configured to allow rotation of the ferrule holder relative to the housing body about the longitudinal axis when the housing cap is not attached to the housing body; and
the housing cap is configured to restrict rotation of the ferrule holder relative to the housing body about the longitudinal axis when the housing cap is attached to the housing body.

2. The fiber optic connector of claim 1, wherein the housing cap includes a first portion configured to be received in a front portion of the housing body and a second portion configured to extend from the housing body, and further wherein the first portion of the housing cap is configured to engage the ferrule holder to restrict rotation of the ferrule holder about the longitudinal axis when the housing cap is attached to the housing body.

3. The fiber optic connector of claim 2, wherein the second portion of the housing cap and the front portion of the housing body have complementary outer geometries.

4. The fiber optic connector of claim 2, wherein when the housing cap is attached to the housing body:
the housing cap and housing body extend in a lengthwise direction of the housing;
the second portion of the housing cap and the front portion of the housing body have respective outer surfaces defining respective outer profiles in a plane transverse to the lengthwise direction; and
the outer profile of the second portion of the housing cap corresponds to the outer profile of the front portion of the housing body.

5. The fiber optic connector of claim 2, wherein when the housing cap is attached to the housing body:
the housing cap and housing body extend in a lengthwise direction of the housing;
the first portion of the housing cap includes inner surfaces defining a hollow passage that receives the front portion of the ferrule holder; and
the hollow passage and the front portion of the ferrule holder have polygonal profiles in a plane transverse to the lengthwise direction of housing.

6. The fiber optic connector of claim 2, wherein:
the first portion of the housing cap includes inner surfaces defining a hollow passage configured to receive a front portion of the ferrule holder when the housing cap is attached to the housing body; and
the hollow passage and the front portion of the ferrule holder have complementary geometries.

7. The fiber optic connector of claim 1, wherein the ferrule holder includes a front portion from which the ferrule extends, a rear portion having a smaller cross-sectional profile than the front portion of the ferrule holder in a plane transverse to the longitudinal axis of the ferrule, and a flange positioned between the front and rear portions of the ferrule holder, the fiber optic connector further comprising:
a spring positioned within the housing body and contacting the flange of the ferrule holder, wherein the ferrule holder is movable relative to the housing along the longitudinal axis of the ferrule between an unmated position and a mated position when the housing cap is attached to the housing body, and further wherein the spring is configured to bias the ferrule assembly toward the mated position.

8. The fiber optic connector of claim 1, wherein the housing cap is configured to be removably attached to the housing body.

9. The fiber optic connector of claim 1, wherein the housing cap and housing body include at least one set of complementary locking features configured to secure the housing cap to the housing body.

10. The fiber optic connector of claim 1, wherein the housing cap is configured so that the ferrule extends beyond the front end of the housing when the housing cap is attached to the housing body.

11. A fiber optic cable assembly, comprising:
a fiber optic cable including at least one optical fiber and a jacket extending around the at least one optical fiber; and
a fiber optic connector installed on an end of the fiber optic cable, the fiber optic connector comprising:
a ferrule extending along a longitudinal axis, wherein the at least one optical fiber is supported in and secured to the ferrule;
a ferrule holder from which the ferrule extends; and
a housing comprising:
a housing body in which the ferrule holder is received; and
a housing cap configured to be attached to the housing body, the housing cap defining a front end of the housing when attached to the housing body, wherein:
the ferrule holder and housing body are configured to allow rotation of the ferrule holder relative to the housing body about the longitudinal axis when the housing cap is not attached to the housing body; and
the housing cap is configured to restrict rotation of the ferrule holder relative to the housing body about the longitudinal axis when the housing cap is attached to the housing body.

12. A fiber optic connector system for installation on a fiber optic cable, comprising:
a fiber optic connector comprising:
a ferrule extending along a longitudinal axis;
a ferrule holder from which the ferrule extends; and
a housing comprising:
a housing body in which the ferrule holder is received; and
a housing cap configured to be attached to the housing body, the housing cap defining a front end of the housing when attached to the housing body, wherein:
the ferrule holder and housing body are configured to allow rotation of the ferrule holder relative to the housing body about the longitudinal axis when the housing cap is not attached to the housing body; and
the housing cap is configured to restrict rotation of the ferrule holder relative to the housing body about the longitudinal axis when the housing cap is attached to the housing body; and
a cover configured to be attached to the housing body instead of the housing cap to retain the ferrule holder in the housing body, wherein when the cover is attached to the housing body:
the ferrule extends through the cover;
the ferrule holder is movable along the longitudinal axis between a first position in which the ferrule holder engages the cover and a second position in which the ferrule holder is spaced from the cover;
the cover is configured to restrict rotation of the ferrule holder relative to the housing body about the longitudinal axis in the first position of the ferrule holder; and
the ferrule holder and housing body are configured to allow rotation of the ferrule holder relative to the housing body about the longitudinal axis in the second position of the ferrule holder.

13. The fiber optic connector system of claim 12, wherein:
the cover comprises a beveled seat and the ferrule holder comprises at least one abutment surface;
the first position is a mated position in which the at least one abutment surface is in contact with the beveled seat; and
the second position is an unmated position in which the at least one abutment surface is spaced from the beveled seat.

14. The fiber optic connector system of claim 12, wherein the housing body comprises an aperture configured to accept a tool for retention of the ferrule holder within the housing when neither the cover nor the housing cap are attached to the housing body.

15. A method of forming a fiber optic cable assembly, comprising:
securing at least one optical fiber of a fiber optic cable to a ferrule of a connector pre-assembly, wherein the connector pre-assembly also includes a ferrule holder from which the ferrule extends, a housing body in which the ferrule holder is received, and a cover attached to the housing body to retain the ferrule holder in the housing body;
tuning the ferrule after securing the at least one optical fiber therein, wherein the tuning of the ferrule comprises causing relative rotation between the ferrule holder and the housing body; and
attaching a housing cap to the housing body in place of the cover to restrict further tuning of the ferrule.

16. The method of claim 15, wherein tuning the ferrule further comprises moving the ferrule holder along a longitudinal axis between a first position in which the ferrule holder engages the cover and a second position in which the ferrule holder is spaced from the cover, and wherein the ferrule holder is in the second position when the ferrule holder is rotated relative to the housing body.

17. The method of claim 15, wherein restricting further tuning further comprises inserting a tool through an aperture in the housing body prior to removing the cover such that the ferrule holder is retained within the housing body after the cover is removed and before the housing cap is attached.

18. The method of claim 17, further comprising removing the tool after the housing cap is attached to the housing body.
